(19) United States
(12) Patent Application Publication
(10) Pub. No.: US 2014/0349119 A1
(43) Pub. Date: Nov. 27, 2014

(54) Polycarbonate Resin Composition

(71) Applicant: Cheil Industries Inc., Gumi-si (KR)

(72) Inventors: Jong Chan Hur, Uiwang-si (KR); O Sung Kwon, Uiwang-si (KR); Jun Ho Chi, Uiwang-si (KR); Hyuck Man Kwon, Uiwang-si (KR); Chang Heon Lee, Uiwang-si (KR)

(21) Appl. No.: 14/361,359

(22) PCT Filed: Dec. 21, 2011
(86) PCT No.: PCT/KR2011/009959

§ 371 Date: Aug. 12, 2014

(30) Foreign Application Priority Data
Dec. 1, 2011 (KR) 10-2011-0127934

(51) Int. Cl. C08L 69/00

(52) U.S. Cl. CPC C08L 69/00; C08L 2201/02; C08L 2205/025; C08L 2205/03
USPC 428/412; 524/127

(57) ABSTRACT

A polycarbonate resin composition according to the present invention comprises: (A) a polycarbonate; (B) a polycarbonate containing a non-phenyl group; (c) a rubber-modified aromatic vinyl graft copolymer; and (D) an aromatic phosphoric acid ester. The polycarbonate resin composition has superior physical balance by being flame retardant, shock resistant, low temperature shock resistant, and chemical resistant.

### TECHNICAL FIELD

The present invention relates to a polycarbonate resin composition. More particularly, the present invention relates to a polycarbonate resin composition, which has balance between excellent flame retardancy, impact resistance, low-temperature impact properties and chemical resistance, and a molded article thereof

### BACKGROUND ART

A polycarbonate resin exhibits excellent heat resistance and transparency, and is thus increasingly applied to wider fields such as exterior materials of electric/electronic products, automobile components, and the like. In addition, to improve notched impact strength and processability, the polycarbonate resin is blended with a styrene-containing copolymer.

In particular, since a rubber-modified styrene copolymer exhibits good processability, excellent impact strength and excellent external appearance, the rubber-modified styrene copolymer is blended with the polycarbonate resin for wide application to electric/electronic products and the like. When a resin is used for electric/electronic products or automobile housings emitting large amounts of heat, it is necessary for the resin to maintain flame retardancy and high mechanical strength. To this end, a technique for improving flame retardancy of a resin by adding a flame retardant to a resin composition has been continuously developed.

Typically, a halogen compound has been used in conjunction with an antimony compound to obtain flame retardancy. However, as harmfulness of a halogen flame retardant was emphasized, interest in a flame retardant composition free from halogens has increased. A flame retardant capable of replacing a halogen compound typically contains phosphorus, silicon, boron, nitrogen, and the like.

Recently, to achieve flame retardancy, the rubber-modified styrene copolymer is blended with a polycarbonate resin, which is likely to form char, and a phosphoric acid ester. However, when an injection-molded article is coated with a paint or dye, or brought into contact with an industrial organic solvent, the injection-molded article can suffer from corrosion due to chemical degradation.

To improve chemical resistance of a PC/ABS blend, a technique for blending the PC/ABS blend with other chemical resistant resins such as polyethylene terephthalate has been developed. However, when the PC/ABS blend is blended with the resin such as polyethylene terephthalate, the PC/ABS blend can be deteriorated in heat resistance and easily hydrolyzed, and thus has a limit in use under high moisture and high temperature conditions.

In addition, Korean Patent Laid-open Publication No. 2007-0071446, No. 2009-0026359 and No. 2010-0022376 disclose a process of blending a resin with other chemical resistant resins to improve chemical resistance of the resin. However, this process provides insignificant improvement in chemical resistance of the resin and cause deterioration in impact properties of the resin.

### DISCLOSURE

### Technical Problem

It is one aspect of the present invention to provide a polycarbonate resin composition exhibiting excellent properties in terms of chemical resistance, fluidity, flame retardancy and heat resistance without deterioration in impact properties.

It is another aspect of the present invention to provide a polycarbonate resin composition exhibiting excellent properties in terms of chemical resistance, fluidity, room temperature/low temperature impact strength, and heat resistance.

The above and other aspects of the present invention can be achieved by the present invention described below in more detail.

### Technical Solution

One aspect of the present invention relates to a polycarbonate resin composition. The polycarbonate resin composition includes: (A) a polycarbonate; (B) a biphenyl group-containing polycarbonate; (C) a rubber-modified vinyl graft copolymer; and (D) an aromatic phosphoric acid ester compound.

In one embodiment, the polycarbonate resin composition may include about 0.1 parts by weight to about 30 parts by weight of the (D) aromatic phosphoric acid ester compound based on 100 parts by weight of a base resin, which includes: about 60% by weight (wt % ) to about 90 wt % of the (A) polycarbonate; about 1 wt % to about 25 wt % of the (B) biphenyl group-containing polycarbonate; and about 5 wt % to about 20 wt % of the (C) rubber-modified vinyl graft copolymer.

The (B) biphenyl group-containing polycarbonate may include repeat structures represented by Formulae 1 and 2.

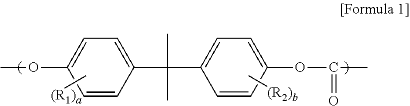

(where R₁ and R₂ are each independently a substituted or unsubstituted C₁ to C₆ alkyl group; and a and b are each independently an integer from 0 to 4)

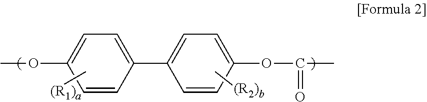

(where R₁ and R₂ are each independently a substituted or unsubstituted C₁ to C₆ alkyl group; and a and b are each independently an integer from 0 to 4)

In one embodiment, a weight ratio of the (A) polycarbonate to the (B) biphenyl group-containing polycarbonate may range from about 3:1 to about 20:1.

In one embodiment, a weight ratio of the (B) biphenyl group-containing polycarbonate to the (C) rubber-modified vinyl graft copolymer may range from about 2:1 to about 1:2.

The (C) rubber-modified vinyl graft copolymer may be a copolymer prepared by graft polymerization of about 10 wt % to about 60 wt % of a rubbery polymer, about 20 wt % to about 80 wt % of an aromatic vinyl monomer, and about 5 wt % to about 45 wt % of a vinyl monomer.

The (D) aromatic phosphoric acid ester compound may be represented by Formula 4.

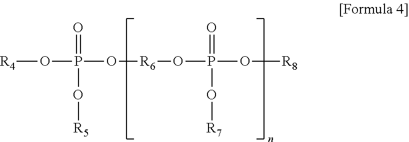

(where R₄, R₅, R₇ and R₈ are each independently a C₈ to C₂₀ aryl group or an alkyl group-substituted aryl group; R₆ is derived from a dialcohol of resorcinol, hydroquinol, bisphenol-A, or bisphenol-S; and n is an integer from 0 to 10)

In one embodiment, the polycarbonate resin composition may have: an Izod impact strength from about 65 kgf·cm/cm to about 95 kgf·cm/cm, as measured on a ⅛″ thick notched specimen at room temperature in accordance with ASTM D256; an Izod impact strength from about 20 kgf·cm/cm to about 80 kgf·cm/cm, as measured on a ⅛″ thick notched specimen at −30° C. in accordance with ASTM D542; a Vicat softening temperature (VST) from about 105° C. to about 130° C., as measured in accordance with ASTM D1525 (a load of 5 kg, 50° C./hr); and a moist heat tensile strength from about 325 kgf/cm² to about 400 kgf·cm², as measured in accordance with ASTM D638 (60° C., a humidity of 90%, 24 hours).

Another aspect of the present invention relates to a molded article including the polycarbonate resin composition as set forth above. The molded article includes a coating layer, which is formed on a surface thereof and includes a paint and a diluent.

### ADVANTAGEOUS EFFECTS

The present invention provides a polycarbonate resin composition, which exhibits excellent properties in terms of chemical resistance, fluidity, flame retardancy and heat resistance without deterioration in impact properties, and exhibits excellent room temperature/low temperature impact strength.

### DESCRIPTION OF DRAWINGS

FIG. 1 is a schematic sectional view of a molded article according to one embodiment of the present invention.

### BEST MODE

As used herein, the term “substituted” means that a hydrogen, is substituted with a halogen atom, a hydroxyl group, a nitro group, a cyano group, an amino group, an azido group, an amidino group, a hydrazino group, a carbonyl group, a carbamyl group, a thiol group, an ester group, a carboxyl group or salt thereof, a sulfonic acid group or salt thereof, a phosphate group or salt thereof, a C₁ to C₂₀ alkyl group, a C₂ to C₂₀ alkenyl group, a C₂ to C₂₀ alkynyl group, a C₁ to C₂₀ alkoxy group, a C₆ to C₃₀ aryl group, a C₆ to C₃₀ aryloxy group, a C₃ to C₃₀ cycloalkyl group, a C₃ to C₃₀ cycloalkenyl group, a C₃ to C₃₀ cycloalkynyl group, or combinations thereof

(A) Polycarbonate

The polycarbonate may be prepared by reacting diphenols represented by Formula 3 with phosgene, a halogen acid ester, a carbonic acid ester, or combinations thereof

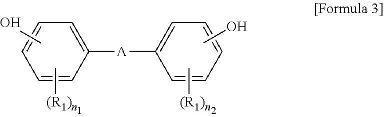

(where A is a substituted or unsubstituted C₁ to C₃₀ linear or branched alkylene group, a substituted or unsubstituted C₂ to C₅ alkenylene group, a substituted or unsubstituted C₂ to C₅ alkylidene group, a substituted or unsubstituted C₁ to C₃₀ linear or branched haloalkylene group, a substituted or unsubstituted C₅ to C₆ cycloalkylene group, a substituted or unsubstituted C₅ to C₆ cycloalkenylene group, a substituted or unsubstituted C₅ to C₁₀ cycloalkylidene group, a substituted or unsubstituted C₆ to C₃₀ arylene group, a substituted or unsubstituted C₁ to C₂₀ linear or branched alkoxylene group, a halogen acid ester group, a carbonic acid ester group, CO, S, or SO₂; R₁ and R₂ are the same or different and are a substituted or unsubstituted C₁ to C₃₀ alkyl group or a substituted or unsubstituted C₆ to C₃₀ aryl group; and n₁ and n₂ are each an integer from 0 to 4).

Two or more diphenols represented by Formula 3 may be combined to constitute a repeat unit of the polycarbonate. Examples of the diphenols may include 2,2-bis(4-hydroxyphenyl)propane (also referred to as “bisphenol-A”), 2,4-bis(4-hydroxyphenyl)-2-methylbutane, bis(4-hydroxyphenyl)methane, 1,1-bis(4-hydroxyphenyl)cyclohexane, 2,2-bis(3-chloro-4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, bis(4-hydroxyphenyl)sulfoxide, bis(4-hydroxyphenyl)ketone, bis(4-hydroxyphenyl)ether, and the like. Preferably, the diphenols are 2,2-bis(4-hydroxyphenyl)propane, 2,2-bis(3,5-dimethyl-4-hydroxyphenyl)propane, or 1,1-bis(4-hydroxyphenyl)cyclohexane. More preferably, the diphenols are 2,2-bis(4-hydroxyphenyl)propane.

The polycarbonate may have a weight average molecular weight from about 10,000 g/mol to about 200,000 g/mol, specifically from about 15,000 g/mol to about 80,000 g/mol, without being limited thereto.

The polycarbonate may be a mixture of copolymers prepared from at least two diphenols. In addition, the polycarbonate may be a linear polycarbonate, a branched polycarbonate, a polyester carbonate copolymer, or the like.

The linear polycarbonate may include bisphenol-A polycarbonates, and the like. The branched polycarbonate may be prepared by reacting diphenols and a carbonate with a polyfunctional aromatic compound, such as trimellitic anhydride, trimellitic acid, and the like. The polyfunctional aromatic compound may be present in an amount of about 0.05 mol % to about 2 mol % based on a total weight of the branched polycarbonate. The polyester carbonate copolymer may be prepared by reacting the diphenols and the carbonate with a bifunctional carboxylic acid. The carbonate may include diaryl carbonates, such as diphenyl carbonate and the like, ethylene carbonate, and the like.

The polycarbonate may have a melt flow index (MFI) from about 3 g/10 min to about 120 g/10 min, as measured at 310° C. under a load of 1.2 kgf.

The polycarbonate constitutes a base resin and may be present in an amount of about 60 wt % to about 90 wt % in the total amount of the base resin. Preferably, the polycarbonate is present in an amount of about 65 wt % to about 85 wt %. Within this range, the polycarbonate resin composition can have balance between impact strength, transparency, heat resistance, and processability.

(B) Biphenyl Group-Containing Polycarbonate

According to the present invention, the (B) biphenyl group-containing polycarbonate may include repeat structures represented by Formulae 1 and 2:

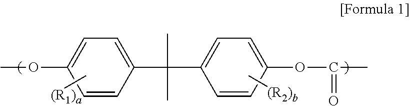

(where R₁ and R₂ are each independently a substituted or unsubstituted C₁ to C₆ alkyl group; and a and b are each independently an integer from 0 to 4)

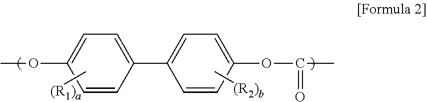

(where R₁ and R₂ are each independently a substituted or unsubstituted C₁ to C₆ alkyl group; and a and b are each independently an integer from 0 to 4).

A mole ratio of the repeat structures represented by Formula 1 to the repeat structures represented by Formula 2 is about 40 mol % to about 95 mol %:about 5 mol % to about 60 mol %, preferably about 50 mol % to about 90 mol %:about 10 mol % to about 50 mol %.

In one embodiment, the biphenyl group-containing polycarbonate may be prepared by transesterification of diols represented by Formulae 1-1 and 2-1 with a diaryl carbonate.

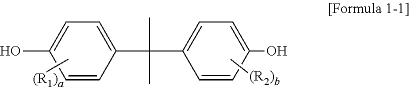

(where R₁ and R₂ are each independently a substituted or unsubstituted C₁ to C₆ alkyl group; and a and b are each independently an integer from 0 to 4).

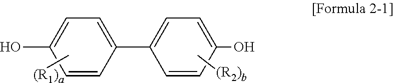

(where R₁ and R₂ are each independently a substituted or unsubstituted C₁ to C₆ alkyl group; and a and b are each independently an integer from 0 to 4).

Examples of the diol represented by Formula 1-1 may include 2,2-bis-(4-hydroxyphenyl)-propane, 2,2-bis-(3,5-dimethyl-4-hydroxyphenyl)-propane, 2,2-bis-(3,5-diisopropyl-4-hydroxyphenyl)-propane, and the like. Preferably, the diol represented by Formula 1-1 is 2,2-bis-(4-hydroxyphenyl)-propane, which is also referred to as bisphenol-A.

Examples of the diol represented by Formula 2-1 may include 4,4′-biphenol, 2,2′-dimethyl 4,4′-biphenyldiol, 3,3-dimethyl 4,4-dihydroxy biphenyl, 2,2′,6,6′,-tetramethyl-4,4′-biphenol, and the like. Preferably, the diol represented by Formula 2-1 is 4,4′-biphenol.

In one embodiment, a mole ratio of the diol represented by Formula 1-1 to the diol represented by Formula 2-1 is about 40 mol % to about95 mol %:about 5 mol % to about 60 mol %. Within this range, the polycarbonate resin composition can have balance between impact strength, chemical resistance and fluidity.

The diaryl carbonate may include diphenyl carbonate, ditolyl carbonate, bis(chlorophenyl) carbonate, m-cresyl carbonate, dinaphthylcarbonate, bis(diphenyl) carbonate, diethyl carbonate, dimethyl carbonate, dibutyl carbonate, dicyclohexyl carbonate, and the like, without being limited thereto. These may be used alone or in combination thereof. Preferably, the diaryl carbonate is diphenyl carbonate.

In one embodiment, a mole ratio of the diol compounds represented by Formulae 1-1 and 2-1 to the diaryl carbonate ranges from about 0.6 to about 1.0, preferably from about 0.7 to about 0.9. Within this range, the polycarbonate resin composition exhibits excellent fluidity, impact strength and chemical resistance, and, particularly, exhibits excellent heat resistance and room temperature impact strength. In addition, the polycarbonate resin composition can secure a low index of refraction and thus exhibits excellent compatibility when blended with other resins.

In one embodiment, transesterification is performed under reduced pressure at about 150° C. to about 300° C., preferably at about 160° C. to about 280° C., more preferably at about 190° C. to about 260° C. Within this range, there are advantages in terms of reaction rate and reduction in side reaction.

In addition, transesterification is performed at a reduced pressure of about 100 torr or less, for example about 75 torr or less, preferably about 30 torr or less, more preferably about 1 torr or less for at least 10 minutes or more, preferably about 15 minutes to about 24 hours, more preferably about 15 minutes to about 12 hours. Within this range, there are advantages in terms of reaction rate and reduction in side reaction.

In one embodiment, the (B) biphenyl group-containing polycarbonate may be prepared through reaction at a temperature from about 160° C. to about 260° C. for about 2 hours to about 9 hours.

Transesterification may be performed in the presence of alkali metal and alkali-earth metal catalysts. Examples of the alkali metal and alkali-earth metal catalysts include LiOH, NaOH, and KOH, without being limited thereto. These may be used alone or in combination thereof. The amount of catalyst may be determined according to the amount of the aromatic dihydroxy compound. In one embodiment, the catalyst may be present in an amount of about 1×10⁻⁸ mol to about 1×10⁻³ mol per 1 mol of the aromatic dihydroxy compound. Within this range, since sufficient reactivity is secured and generation of by-products due to side reaction is minimized, the biphenyl group-containing polycarbonate can exhibit improved thermal stability and color stability.

A mole ratio (M1:M2) of the repeat structures represented by Formula 1 (M1) to the repeat structures represented by Formula 2 (M2) is about 40 mol % to about 95 mol %:about 5 mol % to about 60 mol %, preferably about 50 mol % to about 90 mol %:about 10 mol % to about 50 mol %.

In one embodiment, the mole ratio of the repeat structures represented by Formula 1 (M1) to the repeat structures represented by Formula 2 (M2) satisfies the following condition: M1>M2 (M1: mol % of the repeat structures represented by Formula 1, M2: mol % of the repeat structures represented by Formula 2).

In this case, the polycarbonate resin composition can exhibit particularly excellent heat resistance and room temperature impact strength.

The (B) biphenyl group-containing polycarbonate constitutes the base resin and is present in an amount of about 1 wt % to about 25 wt % , preferably about 5 wt % to about 20 wt % , based on the total amount of the base resin. Within this range, the polycarbonate resin composition can have balance between impact strength, transparency, heat resistance, chemical resistance, flame retardancy and processability.

(C) Rubber-Modified Aromatic Vinyl Graft Copolymer

The rubber-modified aromatic vinyl graft copolymer forms a dispersed phase in the base resin and serves as an impact modifier.

The rubber-modified aromatic vinyl graft copolymer may be prepared by graft copolymerization of a vinyl monomer onto a rubbery polymer.

In one embodiment, the rubber-modified aromatic vinyl graft copolymer may be prepared by graft polymerization of about 10 wt % to about 60 wt % of a rubbery polymer, about 20 wt % to about 80 wt % of an aromatic vinyl monomer, and about 5 wt % to about 45 wt % of a vinyl monomer.

Examples of the rubbery polymer include butadiene rubber, acrylic rubber, ethylene/propylene rubber, styrene/butadiene rubber, acrylonitrile/butadiene rubber, isoprene rubber, ethylene-propylene-diene monomer (EPDM), and polyorganosiloxane/polyalkylmethacrylate rubber composites, without being limited thereto. These may be used alone or in combination thereof.

The rubbery polymer has an average particle diameter from about 0.1 μm to about 1 μm, preferably from about 0.2 μm to about 0.4 μm, in order to improve impact strength and surface properties of a molded article.

The rubbery polymer may be present in an amount of about 10 wt % to about 60 wt % in the rubber-modified vinyl graft copolymer. Within this range, the polycarbonate resin composition can exhibit excellent impact strength, and a coating layer can adhere to a molded article well.

The aromatic vinyl monomer may include styrene, a-methylstyrene, nucleus-substituted styrene, alkyl-substituted styrene, and the like. The aromatic vinyl monomer may be present in an amount of about 20 wt % to about 80 wt % in the rubber-modified vinyl graft copolymer. Within this range, the polycarbonate resin composition can exhibit excellent fluidity.

The vinyl monomer may include acrylonitrile, methacrylonitrile, C₁ to C₈ alkyl methacrylates, C₁ to C₈ alkyl acrylates, maleic anhydride, C₁ to C₄ alkyl N-substituted maleimides, phenyl N-substituted maleimides, and the like. Within this range, the polycarbonate resin composition can have balance between excellent fluidity and chemical resistance.

In addition, the rubber-modified aromatic vinyl graft copolymer may have a core-shell structure.

The rubber-modified aromatic vinyl graft copolymer may be prepared by a method known to those skilled in the art. For example, the rubber-modified aromatic vinyl graft copolymer may be prepared by anyone of emulsion polymerization, suspension polymerization, solution polymerization, and mass polymerization. Preferably, the rubber-modified aromatic vinyl graft copolymer is prepared by introduction of the vinyl monomer in the presence of the rubbery polymer, followed by emulsion polymerization or mass polymerization using a polymerization initiator.

The rubber-modified aromatic vinyl graft copolymer is present in an amount of about 5 wt % to about 20 wt % , preferably about 5 wt % to about 15 wt % in the base resin. Within this range, the polycarbonate resin composition has balance between excellent impact resistance, chemical resistance and heat resistance.

(D) Aromatic Phosphoric Acid Ester Compound

The (D) aromatic phosphoric acid ester compound may be represented by Formula 4:

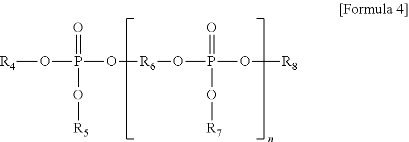

(where R₄, R₅, R₇ and R₈ are each independently a C₆ to C₂₀ aryl group or a C₁ to C₁₀ alkyl group-substituted C₆ to C₂₀ aryl group; R₆ is derived from a dialcohol of resorcinol, hydroquinol, bisphenol-A, or bisphenol-S; and n is an integer from 0 to 10).

The aromatic phosphoric acid ester compound may include: i) triphenyl phosphate, tricresyl phosphate, cresyl diphenyl phosphate, trixylyl phosphate, tri(2,4,6-trimethylphenyl)phosphate, tri(2,4-ditert-butylphenyl)phosphate, tri(2,6-ditert-butylphenyl)phosphate and the like when n is 0; ii) resorcinol bis(diphenyl phosphate), hydroquinol bis(diphenyl phosphate), bisphenol-A-bis(diphenyl phosphate), resorcinol bis(2,6-ditert-butylphenyl phosphate), hydroquinol bis(2,6-dimethylphenyl phosphate) and the like when n is 1; and iii) mixtures in oligomer form when n is 2 or more. These compounds may be used alone or in combination thereof.

The aromatic phosphoric acid ester compound may be used alone or as a mixture with other phosphorus-containing flame retardants. For example, the aromatic phosphoric acid ester compound may further include at least one of other phosphates, phosphonates, phosphinates, phosphine oxide, phosphazenes, and metallic salts thereof.

The aromatic phosphoric acid ester compound is present in an amount of about 0.1 parts by weight to about 30 parts by weight, preferably about 5 parts by weight to about 25 parts by weight, more preferably about 10 parts by weight to about 20 parts by weight, based on 100 parts by weight of the base resin. Within this range, the polycarbonate resin composition can exhibit excellent flame retardancy and appropriate impact strength.

Since the polycarbonate resin composition prepared according to the invention exhibits excellent chemical resistance, fluidity, heat resistance and room temperature/low temperature impact strength, and has balance therebetween, the polycarbonate resin composition can be applied to various products. For example, the polycarbonate resin composition can be used for automobiles, mechanical components, electronic components, office machines including computers and the like, miscellaneous goods, and the like. In particular, the polycarbonate resin composition can be applied to humidifiers, steam cleaners, steam irons and the like as well as housings of electric/electronic products, such as televisions, computers, printers, washing machines, cassette players, audio systems, mobile phones, game consoles, toys and the like. The polycarbonate resin composition may be molded into an article using a typical method, for example, extrusion, injection molding, vacuum molding, cast molding, blow molding, calendering, and the like. These methods are well known by those skilled in the art.

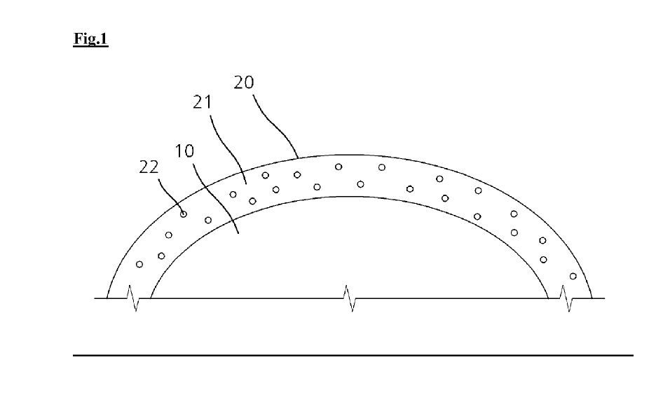

In particular, the composition according to the present invention may be applied to a molded article including a coating layer, which is formed on a surface thereof and includes paint. FIG. 1 is a schematic sectional view of a molded article according to one embodiment of the present invention, on which a coating layer is formed. As shown in FIG. 1, a molded article 10 formed of the composition according to the present invention includes a coating layer 20 on a surface thereof, and the coating layer 20 may include a paint 22 and a diluent 21. The diluent may be an organic solvent including alcohols, oils, and the like. The diluent may be volatilized or removed through post-processing. The paint may include typical organic and inorganic paints.

In this way, since the molded article according to the present invention includes the coating layer which is formed on the surface thereof and includes an organic solvent as the diluent, the molded article requires chemical resistance allowing the molded article to be resistant to the organic solvent. Thus, the composition according to the invention may be applied to the molded article.

Hereinafter, the present invention will be described in more detail with reference to some examples. It should be understood that these examples are provided for illustration only and are not to be construed in any way as limiting the present invention. A description of details apparent to those skilled in the art will be omitted for clarity.

### MODE FOR INVENTION

### EXAMPLES

Details of components used in Examples and Comparative Examples are as follows.

(A) Polycarbonate

PANLITE L-1250WP (Teijin Co., Ltd., Japan) as a bisphenol-A type polycarbonate having a weight average molecular weight of 25,000 g/mol, was used.

(B) Biphenyl Group-Containing Polycarbonate

2.25 kg of 2,2-bis(4-hydroxyphenyl)propane (bisphenol A), 1.90 kg of 4,4′-biphenol, 4.35 kg of diphenyl carbonate, and 150 ppb (based on 1 mol of bisphenol A) of KOH were introduced into a reactor in order, followed by removal of oxygen inside the reactor using nitrogen. The reactor was heated to 160° C., followed by heating the reactor again to 190° C., thereby performing reaction for 6 hours. After 6 hours, the reactor was heated again to 210° C., followed by maintaining the temperature of the reactor at a pressure of 100 torr for 1 hour. The reactor was heated again to 260° C., followed by maintaining the temperature of the reactor at a pressure of 20 torr for 1 hour. Next, the pressure of the reactor was reduced to 0.5 torr, followed by maintaining the pressure thereof for 1 hour. Next, a polymer in a molten state was pelletized using a pelletizer, thereby preparing a pelletized biphenol copolymer.

(C) Rubber-Modified Aromatic Vinyl Graft Copolymer

50 parts by weight of butadiene rubber latex was introduced into a reactor in terms of solid content, followed by adding 36 parts by weight of styrene, 14 parts by weight of acrylonitrile, and 150 parts by weight of deionized water to the reactor. Next, 1.0 part by weight of potassium oleate, 0.4 parts by weight of cumene hydroperoxide, 0.2 parts by weight of a mercaptan chain transfer agent, 0.4 parts by weight of glucose, 0.01 parts by weight of ferrous sulfate monohydrate, and 0.3 parts by weight of sodium pyrophosphate in terms of solid content were introduced into the reactor, followed by maintaining the reactor at 75° C. for 5 hours to complete reaction, thereby preparing a graft copolymer latex. 0.4 parts by weight of sulfuric acid was added to the prepared latex based on the solid content of the resin, followed by coagulation, thereby preparing the graft copolymer latex in a powder state.

(D) Aromatic Phosphoric Acid Ester Compound

Bisphenol A bis(diphenyl phosphate) (CR-741 Grade, Daihachi Chemical Industry Co., Ltd., Japan) was used.

(E) Polyester

SKYGREEN PETG(S2008) (SKC Co., Ltd.) was used.

### Examples 1 to 4 and Comparative Examples 1 to 3

The above components were added in amounts as listed in Table 1, respectively, followed by extrusion at 250° C. using a twin-screw extruder having L/D=35 and Φ=45 mm, and then prepared into pellets using a pelletizer. The prepared pellets were evaluated as to the following properties. Results are shown in Table 1.

Property Evaluation

(1) Flame retardancy: Flame retardancy was evaluated on a 2.0 mm thick specimen according to a UL-94 vertical flammability test method.

(2) Room temperature notched Izod impact strength (kgf·cm/cm): Room temperature notched Izod impact strength was measured on a ⅛″ thick notched Izod specimen in accordance with ASTM D256.

(3) Low temperature Izod impact strength (kgf·cm/cm): Low temperature Izod impact strength was measured on a ⅛″ thick notched Izod specimen at −30° C. in accordance with ASTM D542.

(4) Vicat softening temperature (° C.): Vicat softening temperature (VST) was measured on the prepared specimen using an S6-E tester (Toyo Seiki Co., Ltd.) in accordance with ASTM D1525. Vicat softening temperature was measured at a heating rate of 50° C./hr under a load of 5 kgf in accordance with ISO R306. Vicat softening temperature was measured at a heating rate of 50° C./hr under a load of 5 kg in accordance with ASTM D1525.

(5) Tensile strength after moist heat treatment (Kgf/cm²): A tensile specimen satisfying the ASTM D638 standard was prepared through injection molding, followed by aging at 60° C. at a humidity of 90% for 24 hours, thereby measuring tensile strength in accordance with ASTM D638.

(6) Chemical resistance: A tensile specimen satisfying the ASTM D638 standard was prepared through injection molding, followed by dripping alcohols (methanol and isopropyl alcohol), an industrial oil and an edible oil onto the specimen while 2.1% strain was applied to the specimen in accordance with ASTM D543 environmental stress crack resistance standard. After 10 minutes, whether the specimen suffered from cracks on a curved surface thereof was observed (©: No cracks, O: Fine cracks, A: Large numbers of cracks, X: Haze was observed due to cracks).

TABLE 1

| | | | | | | Comparative | | |
|---|---|---|---|---|---|---|---|---|
| | | Example | | | | Example | | |
| | | 1 | 2 | 3 | 4 | 1 | 2 | 3 |
| (A) PC | | 85 | 80 | 75 | 70 | 90 | 80 | 70 |
| (B) BP-PC | | 5 | 10 | 15 | 20 | — | — | — |
| (C) ABS | | 10 | 10 | 10 | 10 | 10 | 10 | 10 |
| (D) Aromatic | | 15 | 15 | 15 | 15 | 15 | 15 | 15 |
| phosphoric acid ester | | | | | | | | |
| (E) Polyester | | — | — | — | — | — | 10 | 20 |
| Flame retardancy | | V-0 | V-0 | V-0 | V-0 | V-0 | V-0 | V-0 |
| Room temperature | | 70 | 68 | 65 | 62 | 75 | 59 | 14 |
| (25° C.) | | | | | | | | |
| Izod Impact strength | | | | | | | | |
| Low temperature | | 20 | 23 | 32 | 38 | 20 | 18 | 16 |
| (−30° C.) | | | | | | | | |
| Izod Impact strength | | | | | | | | |
| VST (° C.) | | 106 | 109 | 111 | 115 | 103 | 96 | 90 |
| Tensile strength after | | 335 | 332 | 336 | 328 | 330 | 253 | 224 |
| moist heat treatment | | | | | | | | |
| Chemical | Alcohols | Δ | ◯ | ⊚ | ⊚ | X | Δ | ◯ |
| resistance | Edible oil | ◯ | ⊚ | ⊚ | ⊚ | Δ | ◯ | ⊚ |

As shown in Table 1, it can be seen that the resin composition according to the present invention exhibited excellent flame retardancy, impact strength, heat resistance, and chemical resistance. Conversely, it can be seen that the resin composition of Comparative Example 1, which was prepared without the (B) biphenyl group-containing polycarbonate, exhibited low chemical resistance, and that the resin compositions of Comparative Examples 2 to 3, which were prepared using a polyester instead of the (B) biphenyl group-containing polycarbonate, had a limit in improvement of chemical resistance and were particularly deteriorated in impact strength and heat resistance.

It should be understood that the present invention is not limited to the foregoing embodiments and may be embodied in different ways, and that various modifications, changes, alterations, and equivalent embodiments can be made by those skilled in the art without departing from the spirit and scope of the present invention. Therefore, the scope of the invention should be limited only by the accompanying claims and equivalents thereof

1. A polycarbonate resin composition comprising:
(A) a polycarbonate;
(B) a biphenyl group-containing polycarbonate;
(C) a rubber-modified aromatic vinyl graft copolymer; and
(D) an aromatic phosphoric acid ester compound.

2. The polycarbonate resin composition according to claim 1, comprising:
about 0.1 parts by weight to about 30 parts by weight of the (D) aromatic phosphoric acid ester compound based on 100 parts by weight of a base resin, the base resin comprising: about 60 wt % to about 90 wt % of the (A) polycarbonate; about 1 wt % to about 25 wt % of the (B) biphenyl group-containing polycarbonate; and about 5 wt % to about 20 wt % of the (C) rubber-modified aromatic vinyl graft copolymer.

3. The polycarbonate resin composition according to claim 1, wherein the (B) biphenyl group-containing polycarbonate comprises repeat structures represented by Formulae 1 and 2: 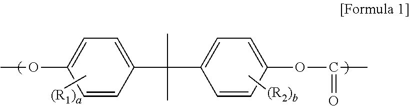
where R₁ and R₂ are each independently a substituted or unsubstituted C₁ to C₆ alkyl group; and a and b are each independently an integer from 0 to 4. 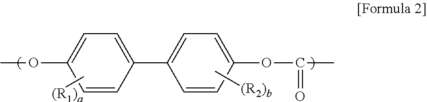
where R₁ and R₂ are each independently a substituted or unsubstituted C₁ to C₆ alkyl group; and a and b are each independently an integer from 0 to 4.

4. The polycarbonate resin composition according to claim 3, wherein the (B) biphenyl group-containing polycarbonate has a mole ratio (M1:M2) of the repeat structures represented by Formula 1 (M1) to the repeat structures represented by Formula 2 (M2) of about 40 mol % to about 95 mol %:about 5 mol % to about 60 mol %.

5. The polycarbonate resin composition according to claim 3, wherein a mole ratio of the repeat structures represented by Formula 1 (M1) to the repeat structures represented by Formula 2 (M2) in the (B) biphenyl group-containing polycarbonate satisfies the following condition:
M1>M2
wherein M1: mol % of the repeat structures represented by Formula 1, and M2: mol % of the repeat structures represented by Formula 2.

6. The polycarbonate resin composition according to claim 1, wherein a weight ratio of the (A) polycarbonate to the (B) biphenyl group-containing polycarbonate ranges from about 3:1 to about 20:1.

7. The polycarbonate resin composition according to claim 1, wherein a weight ratio of the (B) biphenyl group-containing polycarbonate to the (C) rubber-modified aromatic vinyl graft copolymer ranges from about 2:1 to about 1:2.

8. The polycarbonate resin composition according to claim 1, wherein the (C) rubber-modified aromatic vinyl graft copolymer is prepared by graft polymerization of about 10 wt % to about 60 wt % of a rubbery polymer, about 20 wt % to about 80 wt % of an aromatic vinyl monomer, and about 5 wt % to about 45 wt % of a vinyl monomer.

9. The polycarbonate resin composition according to claim 1, wherein the (D) aromatic phosphoric acid ester compound is represented by Formula 4: 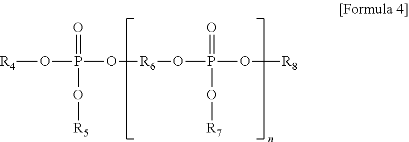
where R₄, R₅, R₇ and R₈ are each independently a C₈ to C₂₀ aryl group or an alkyl group-substituted aryl group; R₆ is derived from a dialcohol of resorcinol, hydroquinol, bisphenol-A, or bisphenol-S; and n is an integer from 0 to 10.

10. The polycarbonate resin composition according to claim 1, wherein the polycarbonate resin composition has: an Izod impact strength from about 65 kgf·cm/cm to about 95 kgf·cm/cm, as measured on a ⅛″ thick notched specimen at room temperature in accordance with ASTM D256; an Izod impact strength from about 20 kgf·cm/cm to about 80 kgf·cm/cm, as measured on a ⅛″ thick notched specimen at −30° C. in accordance with ASTM D256; a Vicat softening temperature (VST) from about 105° C. to about 130° C., as measured in accordance with ASTM D1525 (a load of 5 kg, 50° C./hr); and a moist heat tensile strength from about 325 kgf/cm² to about 400 kgf/cm², as measured in accordance with ASTM D638 (60° C., a humidity of 90%, 24 hours).

11. A molded article molded using the polycarbonate resin composition according to any one of claims 1 to 10, the molded article having a coating layer formed on a surface thereof and comprising a paint and a diluent.
